(19) United States
(12) Patent Application Publication
(10) Pub. No.: US 2006/0156840 A1
(43) Pub. Date: Jul. 20, 2006

(54) Drive rod structure of a tool lock device

(76) Inventors: Ching-Tseng Chu, Taiping City (TW); Chzn-Sung Hsu, Taichung City (TW)

Correspondence Address: LEONG C LEI, PMB # 1008, 1867 YGNACIO VALLEY ROAD, WALNUT CREEK, CA, 94598, US

(21) Appl. No.: 11/020,146

(22) Filed: Dec. 27, 2004

(51) Int. Cl. F16H 57/00

(52) U.S. Cl. 74/404

(57) ABSTRACT

The present invention relates to a drive rod structure of a tool lock device, and more particularly, to a drive rod with the features of easy to be fabricated, finned structure strength and everlasting color. The drive rod comprises a metal rod body and a push head, where the mental rod body is pre-manufactured with a ball-containing groove and an arc-concaved guide edge at one end, and then the opposite end of the rod body is disposed in the push head mold with plastic push head material. The drive rod is formed by one-shot plastic injection combining the plastic push head and the metal rod body. Thus, it can solve the present drive rod problems, which are not easy to be fabricated and have weak structure strength, and reach the features of easy to be fabricated, firmed structure strength and everlasting color. Eventually, the present invention cannot only increase the convenience of the manufacturing and the economic benefits, but only prolong the usage life effectively.

### BACKGROUND OF INVENTION

(a) Technical Field of the Invention

The present invention relates to a drive rod of a tool lock device which functions as a clutch device, and more particularly, to a special design for combining a mental rod body and a plastic push head which will increase variety of the push head and strength of the rod body to reach the purpose of easy-to-fabricate and prolonging the usage life of the drive rod.

(b) Description of the Prior Art

In general, when a tool set needs the function to connect or release its parts, it usually needs a lock device. As shown in FIGS. 1 and 2, a lock device of a ratchet wrench comprises a multi-angle lock rod 11 extending from one end of a ratchet wheel 10 which provides the combination to a corresponding sink hole 35 of a tool head 30, a through hole 15 formed and extending axially in the middle of the ratchet wheel which has a sink hole 17 corresponding to one side of the lock rod 11 for a positioning steel ball 18, a large sink hole 16 forming at the top of the ratchet wheel 10, a drive rod comprising a rod body 21 and a push head 26 corresponding to the through hole 15 and the large sink hole 16 separately. At the other end of the push head 26, the rod body 21 forms a ball-containing groove 22 corresponding to the sink hole 17 of the lock rod 11 and a arc-concaved guide edge 23 which can push the positioning steel ball 18 into the ball-containing groove 22. Additionally, a spring 26 being interposed between the push head 26 of the drive rod 20 and the large sink hole 16 of the ratchet wheel 10 enables the drive rod 20 to spring back.

Thus, the drive rod 20 springs back and move upward to a stable position before users apply force to it, while the arc-concave guide edge 23 of the ball-containing groove 22 in the rod body 21 is capable of pushing the positioning steel ball 18 outward the ratchet wheel 10 surface of the lock rod 11, so as to enable the positioning steel ball 18 to slide into a groove 36 inside the corresponding sink hole 35 of the tool head 30 and to the purpose of locking, as shown in FIG. 2A; On the contrary, when users apply force to the drive rod 20, the spring 26 is compressed and the ball-containing groove 22 of the drive rod 20 moves downward corresponding to the positioning steel ball 18, so as to release the positioning steel ball 18 from the push of the arc-concave guide edge 23. Thus, the positioning steel ball 18 slides into the lock rod 11 and the ratchet wheel 10 separates from the tool head 30, as shown in FIG. 2B, which is convenient for users to connect and release the ratchet wrench.

To consider the identity of a tool set, the above-mentioned drive rod 20 is primarily made of iron and formed by forging for the features of unity, firmed structure strength and material-saving. In general, the metal drive rod 20 is formed by forging, which accompanies lots of peripheral facilities. Meanwhile, the larger the push head 25 is, the more user-friendly it is. However, when the diameter differences between the rod body 21 of the drive rod 20 and the push head 25 of the drive rod 20 are large, the quantity of the forging mold will increase, which will simultaneously increase the manufacturing difficulty and cost. Furthermore, in order to facilitate the users finding the push head 25, the surface of the drive rod 20 or push head 25 will usually be electroplated or painted with colors. The colors, however, easily come off by accident hit and lack variety, which will lose the economic benefits.

Thus, a plastic drive rod 40 is developed, as shown in FIG. 3. The plastic drive rod 40 comprising a rod body 41 and a push head 45 is one-shot design, where the rod body 41, different from the end of the push head 45, has a ball-containing groove 42 and an arc concave guide edge 43. However, the arc concave guide edge 43 is easily deformed from pushing or wearing when it pushes the positioning steel ball 18. Because its plastic body does not have enough hardness and the contact area is too small. Accordingly, the positioning steel ball 18 can not be pushed outward smoothly so that the lock device is out of functions.

As previously described, the present drive rod structures have different problems no matter they are made of metal or plastic. In other words, there is not a drive rod of the lock device which is easy to be fabricated, with enough structure strength and with everlasting color among all the public information. Thus, the present invention is invented to solve all the problems.

Hence, the inventor, owing extensive industry experience in research and manufacturing departments, works hard and tries to search for solutions for the existing drive rod problems. Eventually, he successfully invents a new drive rod structure of a lock device which is easy to be manufactured, with firmed enough structure strength and with everlasting color.

### SUMMARY OF THE INVENTION

The primary purpose of the present invention is to substantially reduce the manufacturing cost and increase the usage life of a tool lock device.

Thus, embodiments of the present invention provide technologies as below descriptions to implement previous mentioned purposes and performances, where a drive rod mainly comprises of a rod body and a push head.

The rod body is made of metal and forms a ball-containing groove at end surface adjacent to the top end. An arc-concave guide edge is formed in the end of the ball-containing groove, adjacent to the top end, in order to push the positioning steel ball.

Subsequently, a kind of colored material is selected for the push head and the rod body is disposed in the push head mold from the end, opposite to the ball-containing groove. By means of one-shot plastic injection technology, the push head with the rod body end are combined in one unity, and further form the complete drive rod.

According to the process, the drive rod manufacturing is simplified effectively while its structure strength is reinforced, and further reaches the features of easy to be fabricated, firmed structure strength and everlasting color to enhance the economic benefits.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded diagram of a representation to a lock device of a ratchet wrench, illustrating structure of the lock device and corresponding location;

FIG. 2A and FIG. 2B is a schematic cross sectional view of a lock device in a ratchet wrench, illustrating structure of the lock device and its operations;

FIG. 3 is an exemplary schematic view of a prior art plastic drive rod of a lock device, illustrating the deformation of the drive rod;

FIG. 4 is a fabricating flow chart of the present invention; and

FIG. 5 is a cross sectional schematic view of the present invention, illustrating the parts of the drive rod and their corresponding positions.

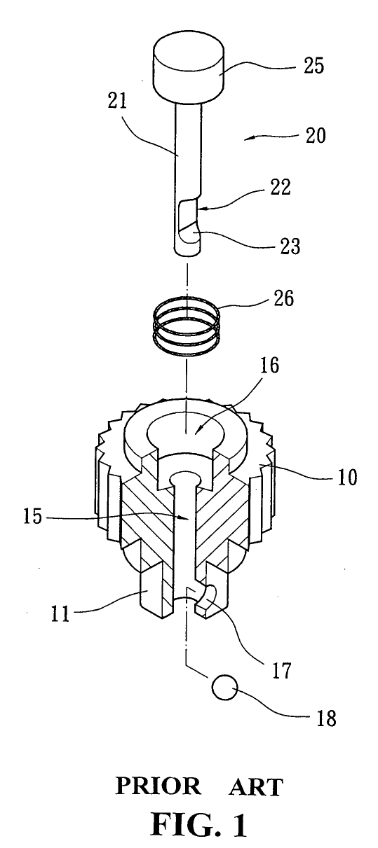

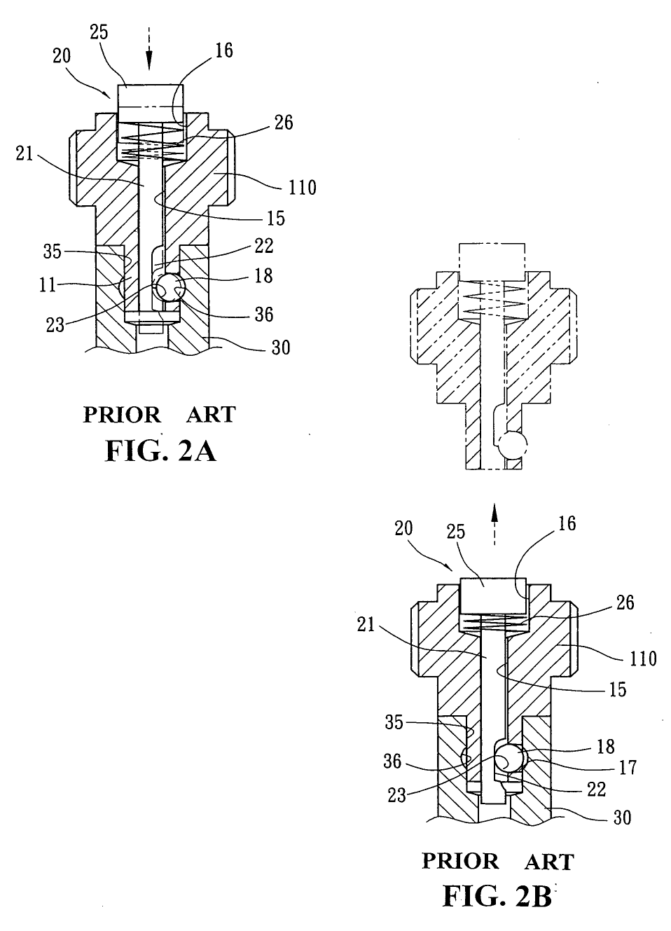

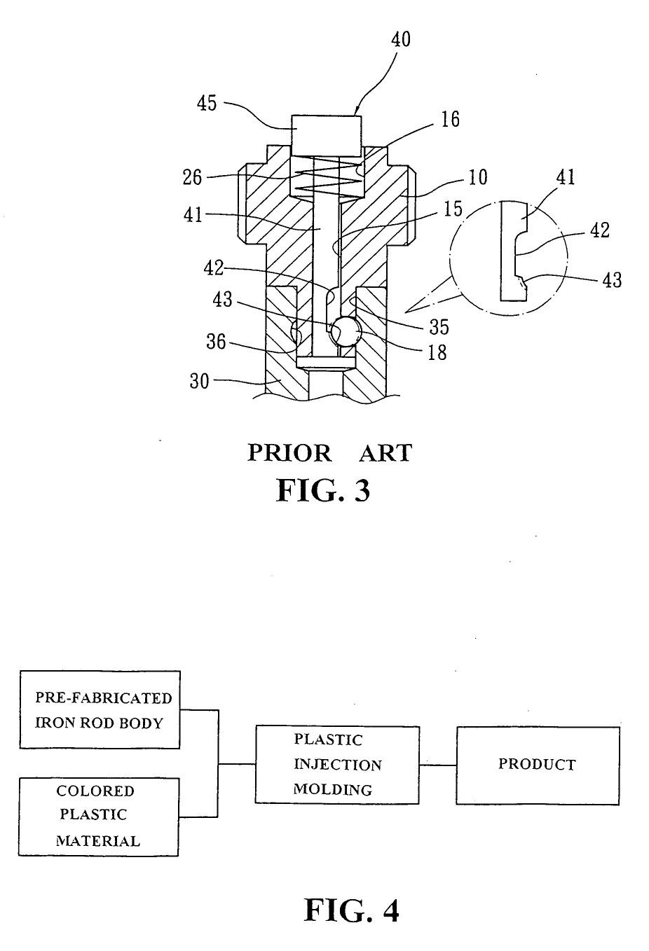

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

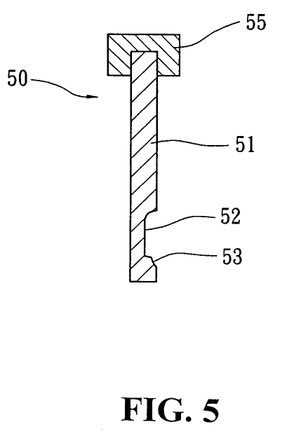

The present invention relates to a drive rod structure of a lock device which is easy to be fabricated, with firmed structure strength and with everlasting color, as shown in FIGS. 4 and 5. The drive rod 50 primarily comprises a metal rod body 51 and a plastic push head 55.

Still referring to FIGS. 4 and 5, the detailed structure of the present invention comprises the rod body 51 made of metallic material, where iron rod is illustrated in the embodiment. The iron rod is first fabricated to semi-manufactures, comprising the rod body 51 forming a ball-containing groove 52 at the top end edge, where an arc-concave guide edge 53 forms at one end adjacent to the top end edge and can push a corresponding positioning steel ball 18 upward.

Subsequently, one kind of material is selected for coloring the push head 55, and then one end of the rod body 51, opposite to the ball-containing groove 52, is disposed into a mold of the push head 55, wherein patterned indented grooves could be formed on the end surface, corresponding to the push head 55, of the rod body 51 for the purpose of enhancing the combination strength. By means of one-shot plastic injection, the push head 55 is formed at one end of the rod body 51 to one unity, which is the finished product of the drive rod 50.

Thus, a pre-fabricated iron rod body 51 is disposed in the mold of the push head 55, and then the drive rod structure of a lock device is formed with one-shot plastic injection combining the push head 55 at one end of the rod body 51, having the features of easy to be fabricated, finned structure strength and everlasting color.

The present invention includes below advantages and values when being practically used:

Easy to be fabricated: The rod body 51 have identical outer diameter, without further being fabricated and needs only pre-forming the ball-containing groove 52 and the arc-concave guide edge 53 by milling. Compared to prior arts, the present invention reduces the manufacturing difficulty greatly and enhances the feature of easy to be fabricated obviously.

(A) Firmed enough structure strength: The rod body 51 is still kept the firmed structure strength as prior arts because of the metallic material. Thus, the arc-concave guide edge 53 of the ball-containing groove 52 does not deform easily and lose its functions. Compared to prior arts, the present invention has the features of not easy to be destroy and prolonging the usage life.

(B) Low cost: As above-described, the present invention includes both the features of easy to be fabricated and firmed enough structure strength, so it can not only cut out the extra manufacturing facilities, human resources, materials, but also reduce the maintenance fee. Thus, the manufacturing cost is decreased greatly.

(C) Everlasting color: the push head 55 is made of a colored plastic material, instead of being electroplated or painted with color on the surface, so it needs only the technology to keep correct color and will not be destroyed by accident hit. Thus, the present invention can enhance its function and prolong its usage life.

To sum up, the present invention simultaneously includes several features and advantages from above-mentioned descriptions, and thus increasing overall economic benefits effectively. Therefore, the present invention is an excellent invention departing from any prior arts in this field and meets the requirements of the patent application. Thus, it is intended to apply to a new model legally.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A drive rod structure of a lock device in tools, comprising:
a rod body and a push head, the rod body formed of metal;
a concaved ball-containing groove formed on the surface of the rod body adjacent to one top end; and
an arc-concaved guide edge formed at one edge of the ball-containing groove adjacent to the top end;
a kind of colored plastic material for the push head and one end of the rod body, opposite to the ball-containing groove, inserted into the push head mold; by means of the one-shot plastic injection, the push head combining the end of the rod body as one unity, and further formed the finished drive rod structure of a tool lock device, having the features of easy to be fabricated, firmed structure strength and everlasting color.

2. The structure according to claim 1, wherein one end of the rod body corresponding to push head forms patterned indented grooves to enhance the combination strength.

3. The structure according to claim 1 or 2, wherein the rod body can be formed of iron.
